(19) United States
(12) Patent Application Publication
(10) Pub. No.: US 2014/0146570 A1
(43) Pub. Date: May 29, 2014

(54) DETACHABLE BULB

(71) Applicant: Lextar Electronics Corporation, Hsinchu Science Park (TW)

(72) Inventors: Wen-Cheng LU, Houlong Township (TW); Chih-Yen LIN, Zhubei City (TW)

(73) Assignee: Lextar Electronics Corporation, Hsinchu Science Park (TW)

(21) Appl. No.: 14/016,718

(22) Filed: Sep. 3, 2013

(30) Foreign Application Priority Data
Nov. 26, 2012 (TW) 101144181

(51) Int. Cl. F21K 99/00

(52) U.S. Cl. CPC F21K 9/30
USPC 362/647

(57) ABSTRACT

A detachable bulb includes a lighting source module and a driving module. The lighting source module includes a support plate, a lighting module, a heat sink, and a light-permeable cover. The heat sink has a cavity, a first end, a second end and an engaging slot disposed on an outer periphery thereof. The support plate is secured on the first end of the heat sink. The light-permeable cover disposed on the first end of the heat sink covering the lighting module. The driving module includes a driving body with a socket, a shell, and a power receiving base. The shell is around the driving body and has several engaging parts that detachably engage with the engaging slot. The power receiving base is electrically connected to the driving body.

### RELATED APPLICATIONS

This application claims priority to Taiwan Application Serial Number 101144181, filed Nov. 26, 2012, which is herein incorporated by reference.

### BACKGROUND

1. Field of Invention

The present invention relates to a bulb. More particularly, the present invention relates to a detachable bulb.

2. Description of Related Art

Lighting equipment is indispensable technology for most people. Lighting equipment includes bulbs and lighting tubes such as the fluorescent tubes, incandescent light bulbs, halogens tubes, and halogens bulbs. However, incandescent light bulbs, halogens tubes, and halogens bulbs consume a large amount of power during operation.

The light-emitting diode (LED) is a semiconductor element. Previously, LEDs were most used as indicator lights in electronic device or as lighting elements in display panels. They are now used also in lighting devices. LED lighting devices have several advantages over traditional lighting devices, such as long lifetime, low power consumption, small size, high shock resistance, and wide applicability. In addition, LED lighting devices are not easily broken and are safer than traditional lighting devices.

The lifespan of the driving circuit of a conventional LED bulb is about 20,000 hours, and the lifespan of the light source of a conventional LED bulb is about 50,000 hours. The driving circuit has poor resistance to high temperature. Consequently, the driving circuit in a high temperature environment of a LED bulb over a prolonged duration of time is broken earlier than the lighting source. When the driving circuit of the conventional LED bulb does not work, the entire LED bulb needs to be replaced with a new one because the driving circuit is welded on the lighting module, making it impossible to replace only the driving device.

Therefore, there is a need to develop a detachable bulb that is capable of avoiding the foregoing disadvantages.

### SUMMARY

In accordance with the present invention, a detachable bulb includes a lighting source module and a driving module. The lighting source module includes a support plate, a lighting module, a heat sink, and a light-permeable cover. The support plate has an opening. The lighting module includes a substrate located on the support plate and several lighting elements located on the substrate. The substrate includes a connecting terminal that is electrically connected to the lighting elements and going through the opening. The heat sink has a cavity, a first end, and a second end, in which the first end is located on one end of the heat sink and the second end is located on an opposite end of the heat sink. The support plate is secured on the first end of the heat sink. In addition, the heat sink has an engaging slot disposed on an outer periphery thereof. The light-permeable cover is disposed on the first end of the heat sink and covers the lighting module. The driving module includes a driving body, a shell, and a power receiving base. The driving body has a socket disposed on a surface thereof. The shell is around the driving body and has several engaging parts circumferentially disposed on a top edge of an inner wall of the shell. The power receiving base is located on a bottom of the shell and electrically connected to the driving body. The connecting terminal of the substrate is detachably plugged into the socket and the engaging parts are detachably engaged with the engaging slot such that the lighting source module is detachably secured with the driving module when the driving body is inserted into the cavity of the heat sink to be coupled with the heat sink.

According to another embodiment disclosed herein, the lighting source module includes a locking part for securing the substrate of the lighting module on the support plate of the heat sink.

According to another embodiment disclosed herein, the locking part is a screw.

According to another embodiment disclosed herein, the shell includes several vents circumferentially disposed thereon.

According to another embodiment disclosed herein, the vents are strip-like.

According to another embodiment disclosed herein, the driving body includes an AC-DC converter.

According to another embodiment disclosed herein, the power receiving base has external threads.

According to another embodiment disclosed herein, the shell substantially funnel-shaped.

According to another embodiment disclosed herein, each of the lighting elements is a light-emitting diode (LED).

According to another embodiment disclosed herein, the lighting elements are circumferentially disposed on the substrate.

In the aforementioned embodiments of the present invention, since the lighting source module is detachably assembled to the driving module, when the bulb is broken, the broken part of the bulb is the lighting source module or the driving module can be know by testing. As a result, the broken lighting source module or the broken driving module can be replaced by a new one, such that the bulb can emit light again normally. Therefore, the lifespan of the bulb can be increased, and the cost for buying new bulbs can be reduced. In addition, when the color temperature or the lighting angle of the bulb is required to change, users only need to change the lighting source module having the corresponding color temperature or the lighting angle, and do not need to buy another bulb, such that the color temperature or the lighting angle of the bulb can be conveniently changed, and the cost for changing the color temperature or the lighting angle of the bulb is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a detachable bulb according to an embodiment of the present invention is applied;

FIG. 2 illustrates a perspective view of the detachable bulb of FIG. 1 after detaching a lighting source module of the detachable bulb from a driving module of the detachable bulb;

FIG. 3 illustrates an exploded view of the detachable bulb of FIG. 1;

FIG. 4 illustrates a top view of a lighting module of the detachable bulb of FIG. 3;

FIG. 5 illustrates a lateral view of the lighting module of the detachable bulb of FIG. 4;

FIG. 6 illustrates a cross-sectional view of the driving module of the detachable bulb along line 6-6′ of FIG. 3;

FIG. 7 illustrates a cross-sectional view of the detachable bulb along line 7-7′ of FIG. 1; and

FIG. 8 illustrates a partial enlarged view of part A of the detachable bulb of FIG. 7.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

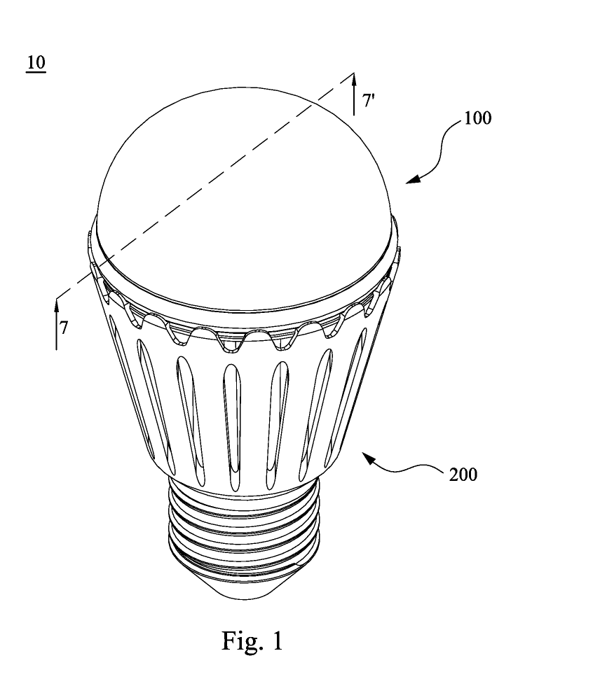

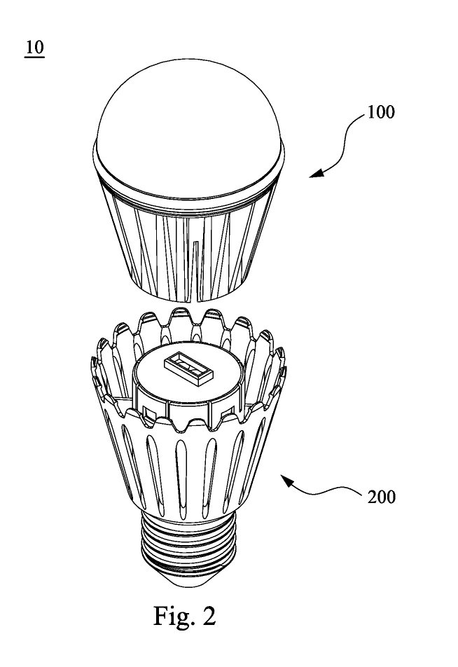

FIG. 1 shows a perspective view of a detachable bulb 10 according to an embodiment of the present invention is applied, and FIG. 2 shows a perspective view of the detachable bulb 10 of FIG. 1 after separating a lighting source module 100 from a driving module 200. The detachable bulb 10 includes the lighting source module 100 and the driving module 200, in which the lighting source module 100 is used to emit light and the driving module 200 is used to supply power to the lighting source module 100 to enable operation of the same.

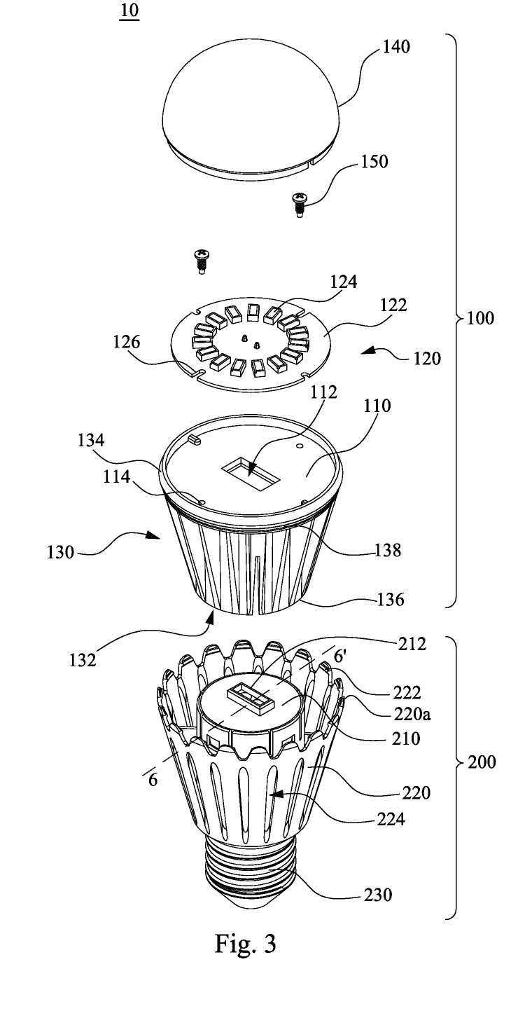

FIG. 3 shows an exploded view of the detachable bulb 10 of FIG. 1. The detachable bulb 10 includes the lighting source module 100 and the driving module 200, as described above.

The lighting source module 100 includes a support plate 110, a lighting module 120, a heat sink 130, and a light-permeable cover 140. The support plate 110 has an opening 112. The lighting module 120 includes a substrate 122 located on the support plate 110 and several lighting elements 124 located on the substrate 122. In this embodiment, the lighting elements 124 are circumferentially disposed on the substrate 122 and located along an edge of the substrate 122.

The heat sink 130 has a cavity 132, a first end 134, and a second end 136, in which the first end 134 is located on one end of the heat sink 130 and the second end 136 is located on an opposite end of the heat sink 130. The support plate 110 is secured on the first end 134 of the heat sink 130 and surrounded by the circumference of heat sink 130. In addition, the heat sink 130 has an engaging slot 138 disposed on an outer periphery thereof. In this embodiment, the support plate 110 and the heat sink 130 are integrally formed as a single piece. In this embodiment, the engaging slot 138 is disposed on the outer periphery of the heat sink 130 near the first end 134 of the heat sink 130, but the present invention is not limited with respect to this configuration or positioning of the engaging slot 138. In another embodiment, the engaging slot 138 may be disposed on a portion of the outer periphery of the heat sink 130. The light-permeable cover 140 is disposed on the first end 134 of the heat sink 130 and covers the lighting module 120 such that light emitted by the lighting module 120 may radiate from the light-permeable cover 140. In this embodiment, each of the lighting elements 124 of the lighting module 120 is a light-emitted diode (LED), but the present invention is not limited in this regard.

In this embodiment, the lighting source module 100 includes a locking part 150 that is secured to both the substrate 122 of the lighting module 120 and the support plate 110 such that the substrate 122 of the lighting module 120 fixed to the support plate 110 and the heat sink 130. The locking part 150 may pass through a notch 126 formed in the substrate 122 and may be coupled to a locking hole 114 of the support plate 110 such that the substrate 122 of the lighting module 120 is secured to the support plate 110. In this embodiment, the locking part 150 is a screw and the locking hole 114 is a threaded hole, but the present invention is not limited in this regard.

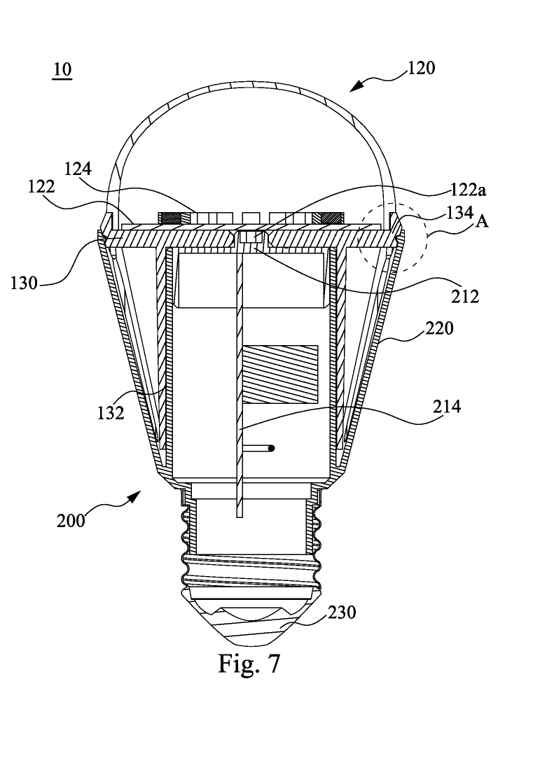

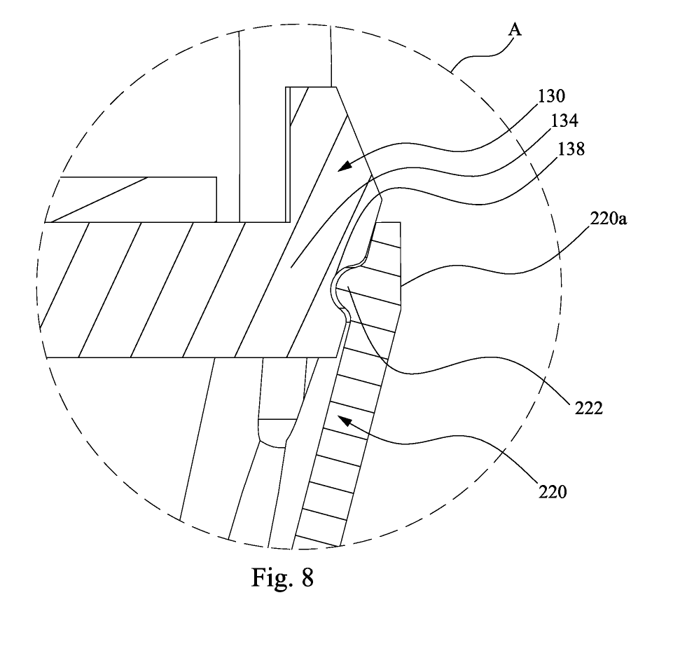

The driving module 200 includes a driving body 210, a shell 220, and a power receiving base 230. The driving body 210 has a socket 212 disposed on a surface thereof for being electrically connected to the substrate 122 of the lighting module 120 such that the driving body 210 may supply power to the lighting module 120. In this embodiment, the socket 212 is disposed on a top surface of the driving body 210, but the present invention is not limited with respect to this configuration of the socket 212. When the lighting source module 100 is secured with the driving module 200, the shell 220 is disposed around the driving body 210. Several engaging parts 222 are circumferentially disposed on a top edge 220a of an inner wall of the shell 220, and the engaging parts 222 may be secured with the engaging slot 138 of the heat sink 130 (such as in FIG. 7 and FIG. 8). In some embodiments, the shell 220 is substantially funnel-shaped. The shell 220 gradually expands radially outward from a bottom of the shell 220 to a top of the shell 220. The power receiving base 230 is located on a bottom of the shell 220 and is electrically connected to the driving body 210. The power receiving base 230 may be connected to a socket (not shown) of an external power source. In this embodiment, the power receiving base 230 has external threads or is made of copper material. In another embodiment, the power receiving base 230 may be a slot-type power receiving base.

In addition, the shell 220 includes several vents 224. The vents 224 are circumferentially disposed on a wall that forms the shell 220. That is, each of the vents 224 is formed in a narrow, strip-like configuration along the wall of the shell 220. Through such a configuration, when the driving body 210 is inserted into the cavity 132 of the heat sink 130 to be coupled with the heat sink 130, the heat sink 130 may be spatially communicated with the external environment through the vents 224 such that the heat sink 130 can better dissipate heat.

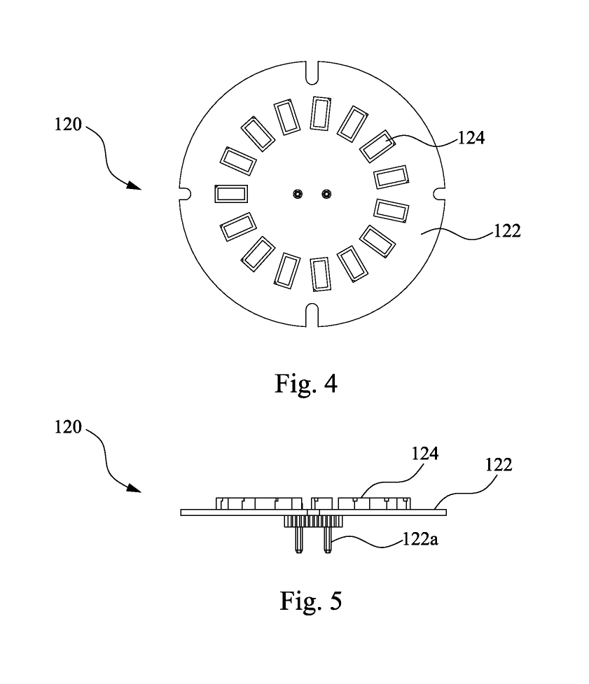

FIG. 4 shows a top view of the lighting module 120 of the detachable bulb 10 of FIG. 3, and FIG. 5 shows a lateral view of the lighting module 120 of the detachable bulb 10 of FIG. 4. The substrate 122 of the lighting module 120 includes a connecting terminal 122a that is electrically connected to the lighting elements 124. When the substrate 122 is connected to the support plate 110, with additional reference to FIG. 3, the connecting terminal 122a may go through the opening 112 of the support plate 110 and be electrically connected to the socket 212 of the driving body 210 such that power may be transmitted from the socket 212 through the connecting terminal 122a to the lighting elements 124 after supply external power source to the power receiving base 230.

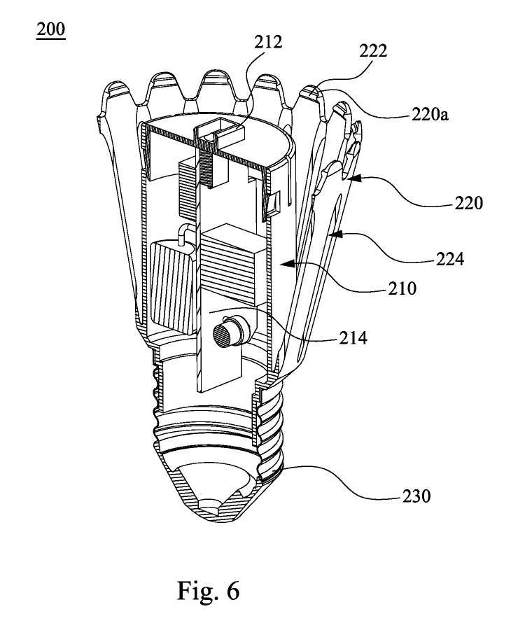

FIG. 6 shows a cross-sectional view of the driving module 200 of the detachable bulb 10 along line 6-6′ of FIG. 3. In this embodiment, the driving body 210 includes an AC-DC converter 214 and some passive elements. The AC-DC converter 214 is electrically connected to the power receiving base 230, and the AC-DC converter 214 is used for converting alternating current into direct current. In addition, the driving body 210 may control the intensity of electric current passed through the lighting elements 124 (see FIG. 3) to reach or be near the desired magnitude and make the current intensity stabilized to reduce the influence of the voltage of an external power supply, the influence of the temperature when providing power, or the influence of a forward bias variation. As a result, the desired luminosities of the lighting elements 124 can be obtained, the lifespan of the lighting elements 124 (see FIG. 3) is prevented from being reduced, or the lighting elements 124 is prevented from being broken.

FIG. 7 shows a cross-sectional view of the detachable bulb 10 along line 7-7′ of FIG. 1. When the driving body 210 is disposed in the cavity 132 of the heat sink 130, the connecting terminal 122a of the substrate 122 is detachably plugged into the socket 212 and the engaging parts 222 are detachably engaged with the engaging slot 138 such that the lighting source module 100 is detachably secured with driving module 200 to form the detachable bulb 10. After the power receiving base 230 is connected to an external power source, the AC-DC converter 214 may convert the alternating current that is supplied by the external power source and received by the power receiving base 230 into direct current, and the connecting terminal 122a of the substrate 122 transmits the direct current to the lighting elements 124 such that the lighting elements 124 operate to emit light.

FIG. 8 shows a partial enlarged view of part A of the detachable bulb 10 of FIG. 7. Referring to FIGS. 7 and 8, when the lighting source module 100 connected with the driving module 200 such that the driving body 210 is disposed in the cavity 132 of the heat sink 130, the first end 134 of the heat sink 130 pushes the top edge 220a of the shell 220 in an outward direction. Afterwards, the top edge 220a of the shell 220 has an elastic recovery in an inward direction, such that the engaging parts 222 are engaged with the engaging slot 138 to thereby lock the lighting source module 100 with the driving module 200. In this embodiment, the engaging slot 138 is an arc-shape slot and the engaging parts 222 are arc-shape bumps. When the lighting source module 100 is secured with the driving module 200 to form the detachable bulb 10, the engaging parts 222 slide into the engaging slot 138 along an arc surface of the engaging parts 222. In addition, when the lighting source module 100 and the driving module 200 are detached from the detachable bulb 10, the engaging parts 222 slide out the engaging slot 138 along the arc surface of the engaging parts 222.

According to above-described embodiments, since the lighting source module is detachably secured with the driving module to form the detachable bulb, when the bulb is broken, the broken part of the bulb is the lighting source module or the driving module can be know by testing. Therefore, the faulty part (i.e., the lighting source module or the driving module) may be replaced with a new one to repair the detachable bulb. Therefore, the detachable bulb may have a longer lifespan, and moreover, costs associated with the detachable bulb may be reduced since it is possible to replace only the faulty part rather than the entire detachable bulb when the same no longer operates. In addition, if it is desired to change the color temperature or the lighting angle of the detachable bulb, the lighting source module may be replaced with a new one that has the desired color temperature or lighting angle. Therefore, the color temperature or the lighting angle of the bulb can be conveniently changed, and the cost for changing the color temperature or the lighting angle of the bulb can also be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A detachable bulb comprising:
a lighting source module comprising:
a support plate having an opening;
a lighting module comprising a substrate located on the support plate and a plurality of lighting elements located on the substrate, wherein the substrate comprises a connecting terminal electrically connected to the lighting elements and going through the opening;
a heat sink having a cavity, a first end located on one end of the heat sink, and a second end located on an opposite end of the heat sink, wherein the support plate is secured on the first end of the heat sink, and the heat sink has an engaging slot disposed on an outer periphery thereof; and
a light-permeable cover disposed on the first end of the heat sink covering the lighting module; and
a driving module comprising:
a driving body having a socket disposed on a surface thereof;
a shell around the driving body and having a plurality of engaging parts circumferentially disposed on a top edge of an inner wall thereof; and
a power receiving base located on a bottom of the shell and electrically connected to the driving body, wherein the connecting terminal of the substrate is detachably plugged into the socket and the engaging parts are detachably engaged with the engaging slot such that the lighting source module is detachably secured with the driving module when the driving body is inserted into the cavity of the heat sink to be coupled with the heat sink.

2. The detachable bulb of claim 1, wherein the lighting source module comprises a locking part for securing the substrate of the lighting module on the support plate of the heat sink.

3. The detachable bulb of claim 2, wherein the locking part is a screw.

4. The detachable bulb of claim 1, wherein the shell comprises a plurality of vents circumferentially disposed thereon.

5. The detachable bulb of claim 4, wherein the vents are strip-like.

6. The detachable bulb of claim 1, wherein the driving body comprises an AC-DC converter.

7. The detachable bulb of claim 1, wherein the power receiving base has external threads.

8. The detachable bulb of claim 1, wherein the shell is substantially funnel-shaped.

9. The detachable bulb of claim 1, wherein each of the lighting elements is a light-emitting diode (LED).

10. The detachable bulb of claim 1, wherein the lighting elements are circumferentially disposed on the substrate.
